(19) United States
(12) Patent Application Publication
(10) Pub. No.: US 2011/0216165 A1
(43) Pub. Date: Sep. 8, 2011

(54) Electronic apparatus, image output method, and program therefor

(75) Inventor: Tomonori Misawa, Tokyo (JP)

(73) Assignee: Sony Corporation, Tokyo (JP)

(21) Appl. No.: 12/932,313

(22) Filed: Feb. 23, 2011

(30) Foreign Application Priority Data
Mar. 4, 2010 (JP) P2010-048435

(51) Int. Cl. H04N 13/02

(52) U.S. Cl. 348/46; 348/E13.074

(57) ABSTRACT

Provided is an electronic apparatus including: a storage to store digital photograph images, shooting date and time information, and shooting location information; a current date and time obtaining unit to obtain a current date and time; a current location obtaining unit to obtain a current location; a controller to draw each of digital photograph images at a drawing position based on the shooting date and time and the shooting location in a virtual three-dimensional space, and to image the virtual three-dimensional space, in which each of digital photograph images is drawn; and an output unit to output the imaged virtual three-dimensional space.

### CROSS-REFERENCE TO RELATED APPLICATION

The present application claims priority from Japanese Patent Application No. JP 2010-048435 filed in the Japanese Patent Office on Mar. 4, 2010, the entire content of which is incorporated herein by reference.

### BACKGROUND OF THE INVENTION

1. Field of the Invention

The present invention relates to an electronic apparatus, which is capable of displaying pieces of image data of digital photograph images and the like, to an image output method in the electronic apparatus, and to a program therefor.

2. Description of the Related Art

In the related art, for example, there has been a technology of displaying a large amount of digital photograph images, which are shot by an electronic apparatus such as a digital camera or the like, with the digital photograph images being arranged as thumbnail images. As the above-mentioned technology, other than a technology in which a plurality of thumbnail images are displayed in a folder in a matrix form, for example, the following technology also exists. Specifically, in the technology, for example, as described in Japanese Patent Application Laid-open No. 2007-66291 (hereinafter, referred to as Patent Literature 1), in a depth direction in a virtual three-dimensional space, each of a plurality of pieces of image data is arranged in a coordinate corresponding to a shooting date of the image.

Further, Japanese Patent Application Laid-open No. 2009-88683 (hereinafter, referred to as Patent Literature 2) discloses a technology of displaying a marginal image of a displayed image through changing an orientation or a tilt in a upper and lower direction of a digital camera, based on shooting information of a shooting orientation angle, a shooting angle, or the like, which is recorded correspondingly to a piece of image data.

### SUMMARY OF THE INVENTION

However, in the technology described in Patent Literature 1, it is difficult for a user to grasp a shooting location (orientation) of a piece of image data. Meanwhile, in the technology described in Patent Literature 2, it is difficult for a user to grasp a shooting time of a piece of image data.

In view of this, for example, the following method is conceivable. Specifically, in the method, in such a manner that the virtual three-dimensional space described in Patent Literature 1 is extended in a horizontal direction (circumferential direction) about a view-point of a user, each of pieces of image data is displayed at a coordinate position corresponding to not only the shooting time but also the shooting location (orientation) thereof. However, in this case, through in the virtual three-dimensional space, more space is formed while going particularly to the depth direction, an appearance of each of pieces of image data becomes small at the same time, and hence a space not used as a space in which the pieces of image data are arranged is increased. Further, as smaller pieces of image data are displayed, it is necessarily more difficult for the user to recognize them

In view of the above-mentioned circumstances, there is a need for providing an electronic apparatus, which is capable of efficiently using a virtual three-dimensional space in which photograph images are arranged and improving, at the same time, convenience in viewing the photograph images, an image output method in the electronic apparatus, and a program therefor.

According to an embodiment of the present invention, there is provided an electronic apparatus. The electronic apparatus includes a storage, a current date and time obtaining unit, a current location obtaining unit, a controller, and an output unit. The storage stores a plurality of digital photograph images, shooting date and time information indicating a shooting date and time of each of the digital photograph images, and shooting location information indicating a shooting location of each of the digital photograph images. The current date and time obtaining unit obtains a current date and time. The current location obtaining unit obtains a current location. The controller draws each of digital photograph images at a drawing position based on the shooting date and time and the shooting location in a virtual three-dimensional space. The virtual three-dimensional space includes one of a time axis corresponding to the shooting date and time and a distance axis corresponding to the shooting location in a radial direction of a circle having a center at a view-point of a user, the view-point corresponding to the current date and time and the current location. Further, The virtual three-dimensional space includes a direction axis corresponding to the shooting location in a circumferential direction of the circle. In this case, the controller draws each of digital photograph images in such a manner that each of digital photograph images has a size proportional to a distance from the view-point to the drawing position. The controller images the virtual three-dimensional space, in which each of digital photograph images is drawn, for a predetermined range of field of view from the view-point. The output unit outputs the imaged virtual three-dimensional space.

With this, the electronic apparatus draws each of the digital photograph images in the virtual three-dimensional space in such a manner that each of the digital photograph images have an increased size in proportion to the distance from the view-point, and hence it is possible to efficiently use the virtual three-dimensional space particularly in a radial direction thereof (time axis direction or distance axis direction). Further, with this, it becomes easier for the user to view and choice each of the digital photograph images in the output virtual three-dimensional space. An apparent size of each of the output digital photograph images will be substantially the same size, for example, irrespective of the drawing position on the time axis or the distance axis. Here, the electronic apparatus refers, for example, to a portable terminal such as a mobile phone, a smart phone, or a note book PC (Personal Computer). However, the electronic apparatus may be other portable electronic apparatuses or a stationary electronic apparatus.

The virtual three-dimensional space may include the time axis in the radial direction. In this case, the controller may be capable of selectively performing a first mode and a second mode. In the first mode, the controller draws each of the digital photograph images in such a manner that a distance from the view-point to the drawing position of each of the digital photograph images on the time axis is proportional to the shooting date and time. Further, in the second mode, the controller draws each of the digital photograph images in such a manner that the distance from the view-point to the drawing position of each of the digital photograph images on the time axis is proportional to a shooting order of each of the digital photograph images, the shooting order being calculated based on the shooting date and time.

With this, the electronic apparatus performs the first mode, which allows for the user to intuitively grasp the shooting date and time of each of the digital photograph images and an interval between a shooting date and time and another shooting date and time in the virtual three-dimensional space. When the electronic apparatus performs the second mode, it is possible to efficiently use the virtual three-dimensional space, even in a case where an interval between a shooting date and time and another shooting date and time of the digital photograph images is large, in such a manner that the interval is set to be smaller so as to prevent the entire digital photograph images from being widely spread.

The controller may determine whether or not an interval between a shooting date and time of a first image of the digital photograph images and another shooting date and time of a second image of the digital photograph images is equal to or smaller than a predetermined value. In this case, the first image and the second image are adjacent to each other in time sequence. The controller may perform the first mode when the controller determines that the interval is equal to or smaller than the predetermined value. The controller may perform the second mode when the controller determines that the interval is larger than the predetermined value.

With this, the electronic apparatus automatically selects the first mode and the second mode to be performed correspondingly to the length of the interval between a shooting date and time and another shooting date and time of the digital photograph images, and hence it is possible to efficiently use the virtual three-dimensional space all the time.

The controller may draw, in the virtual three-dimensional space imaged for the predetermined range of field of view, an overhead-view image indicating as an overhead-view a drawing position of each of the digital photograph images drawn in all directions, the view-point, and the range of the field of view.

With this, the user can intuitively grasp, in the entire digital photograph images, a position and a current range of a field of view of a digital photograph image that the user is currently viewing, during a time when the user is locally viewing each of the digital photograph images per the direction and per a time.

The controller may draws, in the virtual three-dimensional space imaged for the predetermined range of field of view, a number line image indicating an angle of the direction, the angle corresponding to the range of the field of view.

With this, the user can easily grasp which direction the current range of the field of view of the user corresponds to.

According to another embodiment of the present invention, there is provided an image output method. The image output method includes: storing a plurality of digital photograph images, shooting date and time information indicating a shooting date and time of each of the digital photograph images, and shooting location information indicating a shooting location of each of the digital photograph images; obtaining a current date and time; and obtaining a current location. Each of digital photograph images is drawn at a drawing position based on the shooting date and time and the shooting location in a virtual three-dimensional space. The virtual three-dimensional space includes one of a time axis corresponding to the shooting date and time and a distance axis corresponding to the shooting location in a radial direction of a circle having a center at a view-point of a user, the view-point corresponding to the current date and time and the current location. Further, the virtual three-dimensional space includes a direction axis corresponding to the shooting location in a circumferential direction of the circle. In this case, each of digital photograph images is drawn in such a manner that each of digital photograph images has a size proportional to a distance from the view-point to the drawing position. The virtual three-dimensional space, in which each of digital photograph images is drawn, is imaged and output for a predetermined range of field of view from the view-point.

According to another embodiment of the present invention, there is provided a program configured to cause an electronic apparatus to execute a storing step, a current date and time obtaining step, a current location obtaining step, a drawing step, an imaging step, and an outputting step. In the storing step, stored are a plurality of digital photograph images, shooting date and time information indicating a shooting date and time of each of the digital photograph images, and shooting location information indicating a shooting location of each of the digital photograph images. In the current date and time obtaining step, a current date and time is obtained. In the current location obtaining step, a current location is obtained. In the drawing step, each of digital photograph images is drawn at a drawing position based on the shooting date and time and the shooting location in a virtual three-dimensional space. The virtual three-dimensional space includes one of a time axis corresponding to the shooting date and time and a distance axis corresponding to the shooting location in a radial direction of a circle having a center at a view-point of a user, the view-point corresponding to the current date and time and the current location. Further, the virtual three-dimensional space includes a direction axis corresponding to the shooting location in a circumferential direction of the circle. In this case, each of digital photograph images is drawn in such a manner that each of digital photograph images has a size proportional to a distance from the view-point to the drawing position. In the imaging step, the virtual three-dimensional space, in which each of digital photograph images is drawn, is imaged for a predetermined range of field of view from the view-point. In the outputting step, the imaged virtual three-dimensional space is output.

As described above, according to the embodiments of the present invention, it is possible to efficiently use a virtual three-dimensional space in which photograph images are arranged and improve, at the same time, convenience in viewing the photograph images.

### BRIEF DESCRIPTION OF DRAWINGS

FIG. 1 is a view showing a hardware configuration of a portable terminal according to an embodiment of the present invention;

FIG. 2 is a view conceptually showing a first display mode of a virtual three-dimensional space in the embodiment of the present invention;

FIG. 3 is a view conceptually showing the virtual three-dimensional space displayed in the first display mode in the embodiment of the present invention;

FIG. 4 is a view conceptually showing a second display mode of the virtual three-dimensional space in the embodiment of the present invention;

FIG. 5 is a view conceptually showing the virtual three-dimensional space displayed in the second display mode in the embodiment of the present invention;

FIG. 6 is an explanatory view for coordinate axes of the virtual three-dimensional space and the size of each of photographs arranged on the coordinate axes in the embodiment of the present invention;

FIG. 7 is an explanatory view for a method of specifying a position in which an image is arranged in the virtual three-dimensional space of the embodiment of the present invention;

FIG. 8 is an explanatory view for a first calculation method for the size of a photograph in the embodiment of the present invention;

FIG. 9 is an explanatory view for a second calculation method for the size of the photograph in the embodiment of the present invention;

FIG. 10 is an explanatory view for a first conversion method into a distance corresponding to a shooting date and time in the embodiment of the present invention;

FIG. 11 is an explanatory view for a second conversion method into the distance corresponding to the shooting date and time in the embodiment of the present invention;

FIG. 12 is a flowchart of display processes according to the first display mode of the virtual three-dimensional space in the embodiment of the present invention;

FIG. 13 is a flowchart of display processes according to the second display mode of the virtual three-dimensional space in the embodiment of the present invention;

FIG. 14 is a flowchart of automatic switching processes between the first conversion method and the second conversion method into the distance corresponding to the shooting date and time in the embodiment of the present invention;

FIG. 15 is a table showing an elapsed time t[n] since a first image of actually shot images has been shot and a shooting interval diff[n]=t[n+1]−t[n] in the embodiment of the present invention;

FIG. 16 is a view in which an ideal value of the time difference of each of the photographs after processed in the automatic selection process of the conversion method for the shooting date and time into the distance in FIG. 15 is shown as a modified time difference;

FIG. 17 is a table showing a result of calculating the distance from the view-point to a position at which each of the photographs have to be arranged in the virtual three-dimensional space through performing a process according to the method shown in FIG. 16;

FIG. 18 is a graph showing a result before the automatic selection process of the conversion method for the shooting date and time into the distance and a result after the automatic selection process of the conversion method for the shooting date and time into the distance in the embodiment of the present invention;

FIG. 19 is a view showing an actual output example of the virtual three-dimensional space in the embodiment of the present invention;

FIG. 20 is a view showing an actual output example of the virtual three-dimensional space in the embodiment of the present invention;

FIG. 21 is a view showing an actual output example of the virtual three-dimensional space in the embodiment of the present invention;

FIG. 23 are views each showing an actual output example of the virtual three-dimensional space in the embodiment of the present invention; and

FIG. 24 are views each showing an actual output example of the virtual three-dimensional space in the embodiment of the present invention.

### DESCRIPTION OF PREFERRED EMBODIMENTS

Hereinafter, an embodiment of the present invention will be described with reference to the drawings.

### [Hardware Configuration of Portable Terminal]

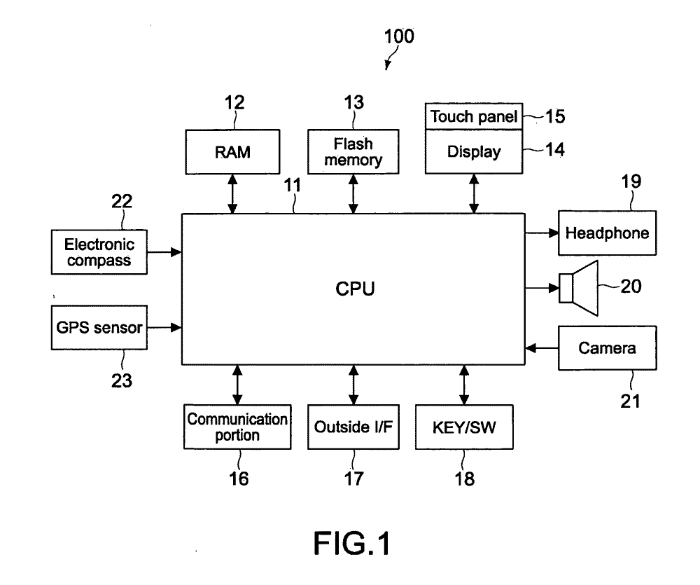

FIG. 1 is a view showing a hardware configuration of a portable terminal according to an embodiment of the present invention. Specifically, the portable terminal means a mobile phone, a smart phone, a PDA (Personal Digital Assistant), a portable type AV player, an electronic book, an electronic dictionary, or the like.

The portable terminal 100 includes a CPU 11, an RAM 12, a flash memory 13, a display 14, a touch panel 15, a communication portion 16, an outside I/F (interface) 47, a key/switch portion 18, a headphone 19, and a speaker 20. In addition, the portable terminal 100 includes a camera 21, an electronic compass 22, and a GPS (Global Positioning System) sensor 23. In addition to the above-mentioned components, the portable terminal 100 may include an antenna for a telephone call, a communication module for a telephone call, and the like.

The CPU 11 transmits and receives with respect to each of the blocks of the portable terminal 100 and performs various computing processes, to thereby control the overall processes to be performed in the portable terminal 100, such as a drawing process of digital photograph images with respect to the virtual three-dimensional space, which will be described later.

The RAM 12 is used as a working area of the CPU 11. The RAM 12 temporarily stores various pieces of data of contents and the like to be processed by the CPU 11, and programs of an application for drawing and displaying the digital photograph images in the virtual three-dimensional space (hereinafter, referred to as photograph-displaying application) and the like.

The flash memory 13 is one of an NAND type, for example. The flash memory 13 stores various contents such as the digital photograph images (hereinafter, abbreviated to photographs) shot by the camera 21 and dynamic images, a control program to be performed by the CPU 11, and various programs of the photograph-displaying application and the like. Further, the flash memory 13 reads, when the photograph-displaying application is executed, various pieces of data of photographs and the like, which are necessary for the execution, into the RAM 12. The various programs may be stored in another storage medium such as a memory card (not shown). Further, the portable terminal 100 may include an HDD (Hard Disk Drive) as a storage apparatus in place to or in addition to the flash memory 13.

The display 14 is, for example, an LCD or an OELD (Organic Electro-Luminescence Display) including a TFT (Thin Film Transistor) or the like, and displays images of photographs and the like. Further, the display 14 is provided so as to be integrated with the touch panel 15. The touch panel 15 detects a touch operation by a user and transmits the detected operation to the CPU 11 in such a state that the photograph and a GUI (Graphical User Interface) are displayed due to the execution of the photograph-displaying application, for example. As a method of operating the touch panel 15, for example, a resistive film method or a static capacitance method is used. However, other methods including an electromagnetic induction method, a matrix switch method, a surface acoustic wave method, an infrared method, and the like may be used. The touch panel 15 is used for allowing a user to choose a photograph and perform a full-screen display or a change of the view-point thereof (zoom-in or zoom-out) during the time when the photograph-displaying application is being executed, for example.

The communication portion 16 includes, for example, a network interface card and a modem. The communication portion 16 performs a communication process with respect to other apparatuses through a network such as Internet or an LAN (Local Area Network). The communication portion 16 may include a wireless LAN (Local Area Network) module, and may include a WWAN (Wireless Wide Area Network) module.

The outside I/F (interface) 17 conforms to various standards of a USB (Universal Serial Bus), an HDMI (High-Definition Multimedia Interface), and the like. The outside I/F (interface) 17 is connected to an outside apparatus such as a memory card and transmits and receives pieces of data with respect to the outside apparatus. For example, photographs shot by another digital camera are stored through outside I/F 17 into the flash memory 13.

The key/switch portion 18 receives particularly operations by user through a power source switch, a shutter button, short cut keys, and the like, which are may be impossible to be input through the touch panel 15. Then, the key/switch portion 18 transmits input signals thereof to the CPU 11.

The headphone 19 and the speaker 20 output audio signals, which are stored in the flash memory 13 or the like, or which are input through the communication portion 16, the outside I/F 17, or the like.

The camera 21 shoots still images (photographs) and dynamic images through an image pick-up device such as a CMOS (Complementary Metal Oxide Semiconductor) sensor or a CCD (Charge Coupled Device) sensor. The shot pieces of data are stored in the RAM 12 or the flash memory 13, or are transferred through the communication portion 16 or the outside I/F 17 to another apparatus.

The camera 21 is capable of obtaining not only the shot pieces of data of the photographs and dynamic images, but also a shooting date and time and a shooting location thereof, and of storing the shooting date and time and the shooting location together with the shot pieces of data in the flash memory 13 or the like. The shooting date and time is obtained through a clock (not shown) built in the portable terminal 100. The date and time of the built-in clock may be corrected based on date and time information to be received from a base station through the communication portion 16 or on date and time information to be received from a GPS satellite by the GPS sensor 23.

The GPS sensor 23 receives GPS signals transmitted from the GPS satellite, and outputs the GPS signals to the CPU 11. Based on the GPS signals, in the CPU 11, a current location of the portable terminal 100 is detected. From the GPS signals, not only location information in a horizontal direction, but also location information (altitude) in a vertical direction may be detected. Further, without the GPS sensor 23, the portable terminal 100 may perform a trilateration between the portable terminal 100 and base stations through the wireless communication by the communication portion 16, to thereby detect the current location of the portable terminal 100.

The electronic compass 22 includes a magnetic sensor configured to detect the geomagnetism generated from the earth. The electronic compass 22 calculates an azimuth direction, to which the portable terminal 100 is oriented, based on the detected geomagnetism, and outputs the calculated azimuth direction to the CPU 11.

### [Virtual Three-Dimensional Space]

In this embodiment, the portable terminal 100 is capable of drawing (arranging) the photographs, which are stored in the flash memory 13 or the like, in the virtual three-dimensional space, and of displaying the virtual three-dimensional space in which the photographs are drawn, as a two-dimensional image. In this embodiment, the portable terminal 100 is capable of representing the virtual three-dimensional space in two display modes, and further capable of switching between the both display modes anytime during the time when the photograph-displaying application is being executed.

### (First Display Mode of Virtual Three-Dimensional Space)

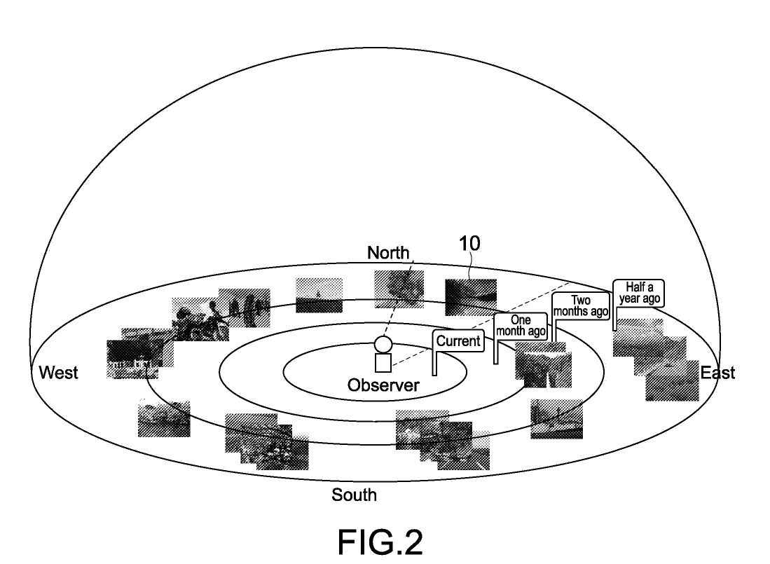

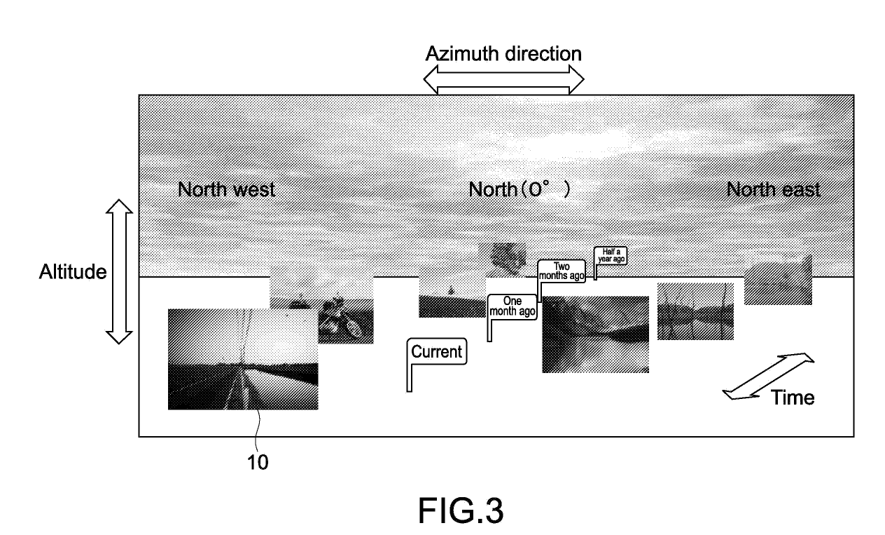

First, a first display mode of the virtual three-dimensional space will be described. FIG. 2 is a view conceptually showing the virtual three-dimensional space in a first display mode. Further, FIG. 3 is a view conceptually showing the virtual three-dimensional space, which is drawn in the first display mode and is displayed on the display 14.

As shown in FIG. 2, the following semi-spherical virtual three-dimensional space in 360° is assumed. Specifically, in the semi-spherical virtual three-dimensional space, a concentric circle is drawn about an observer (view-point of user of portable terminal 100), a radial direction of the concentric circle is set to correspond to a depth direction, and a circumferential direction is set to correspond to the azimuth direction. The portable terminal 100 arranges a photograph 10 at a position in the virtual three-dimensional space, the position corresponding to the shooting date and time and the shooting location of the photograph 10. The portable terminal 100 draws and displays the virtual three-dimensional space in such a manner that the virtual three-dimensional space looks like a background as seen from the view-point of the user as shown in FIG. 2.

In the first display mode, as shown in FIG. 2, a horizontal axis of the virtual three-dimensional space corresponds to the azimuth direction, a vertical axis of the virtual three-dimensional space corresponds to the altitude, and a depth axis of the virtual three-dimensional space corresponds to a time. Specifically, the horizontal axis indicates the azimuth direction to the location where the photograph 10 has been shot, as seen from the current location of the portable terminal 100. Further, the depth axis indicates the date and time when the photograph 10 has been shot, while a current date and time is set as a reference point. Further, the vertical axis indicates the elevation above the earth's surface at the location where the photograph 10 has been shot. In a case where the altitude information is not recorded together with the photograph, the altitude thereof is set to 0, and the photograph 10 is arranged along the earth's surface (bottom surface of virtual three-dimensional space).

A time interval arranged to the depth direction may be a fixed interval including one hour interval, or one day interval, and the like. Alternatively, the time interval arranged to the depth direction may be a variable interval. In this case, as a distance from the view-point becomes larger, for example, one hour, one day, one year, ten years, and so on, the interval becomes larger in an exponential manner. In both of FIG. 2 and FIG. 3, the example in which the variable interval is used is shown.

In the first display mode, the virtual three-dimensional space has a perspective in the depth direction. Thus, on the display 14, the size of the photographs is varied correspondingly to an interval between the current date and time and the shooting date and time of each of the photographs when the photographs are displayed. Meanwhile, in the vertical axis direction, the virtual three-dimensional space has no perspective. Thus, even when the altitudes of respective photographs are different from each other, the photographs are displayed with the same size as long as the shooting date and time of each of the photographs is the same. Further, in the vertical axis direction, photographs each having such an altitude that the photograph departs from a range in which the display 14 is capable of displaying the photographs can be displayed through an upper and lower scroll operation by the user, for example. However, a display mode in which the virtual three-dimensional space has a perspective also in the vertical axis direction may be employed.

### (Second Display Mode of Virtual Three-Dimensional Space)

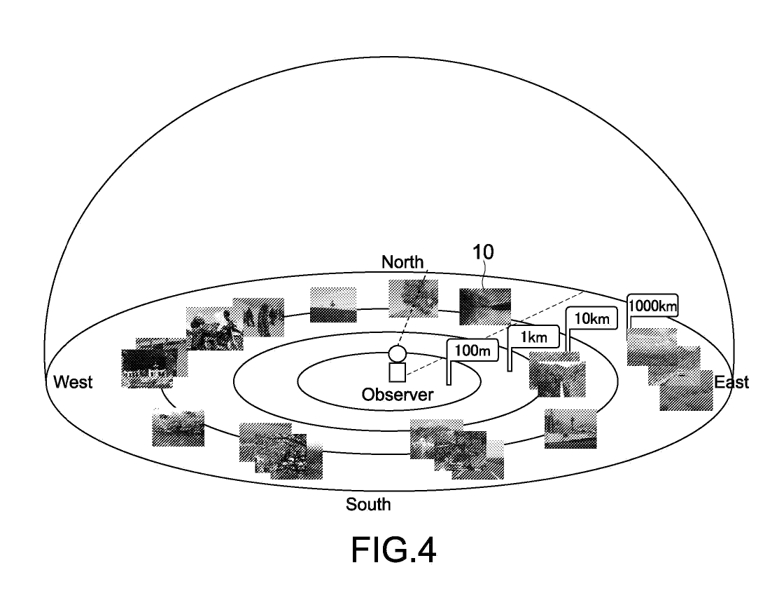

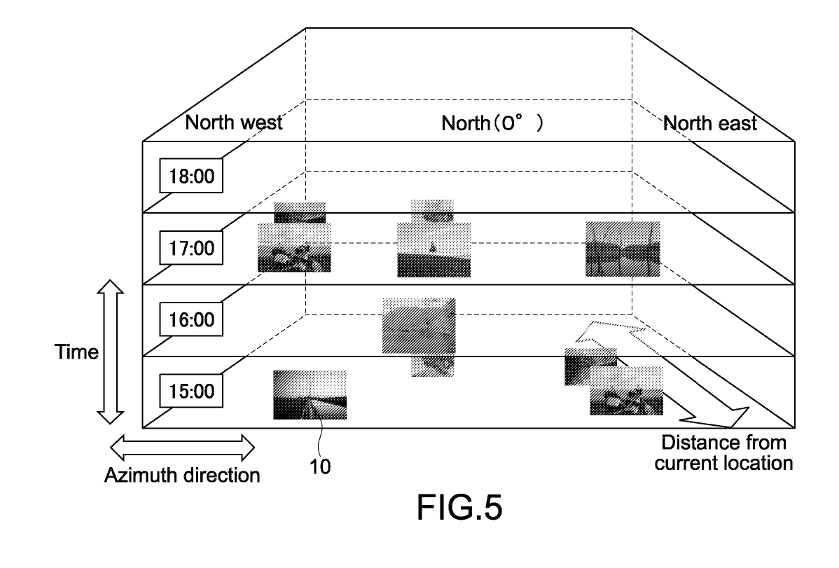

Now, a second display mode of the virtual three-dimensional space will be described. FIG. 4 is a view conceptually showing the virtual three-dimensional space in the second display mode. Further, FIG. 5 is a view conceptually showing the virtual three-dimensional space, which is drawn in the second display mode and which is displayed on the display 14.

In the second display mode, as shown in FIG. 4, a horizontal axis of the virtual three-dimensional space corresponds to the azimuth direction, a vertical axis of the virtual three-dimensional space corresponds to the time, and a depth axis of the virtual three-dimensional space corresponds to a distance (distance from current location of portable terminal 100). Specifically, the horizontal axis indicates the azimuth direction to the location where the photograph 10 has been shot, as seen from the current location of the portable terminal 100. Further, the vertical axis indicates the shooting date and time of the photograph 10, and the depth axis indicates a distance between the current location of the portable terminal 100 and the location where the photograph 10 has been shot. A time interval arranged to the vertical axis direction may be a fixed interval or a variable interval similarly to the first display mode. In FIG. 5, the example in which the variable interval is used is shown.

Also in the second display mode, the virtual three-dimensional space has a perspective in the depth direction. Thus, on the display 14, the size of each photograph is varied correspondingly to a distance between the current location and the photograph when the photograph is displayed. Meanwhile, in the vertical axis direction, the virtual three-dimensional space has no perspective. Thus, even when a shooting date and time of a photograph is different from a shooting date and time of another photograph, the photographs are displayed with the same size as long as the above-mentioned distance is the same. Further, in the vertical axis direction, photographs each having such a date and time width that the photograph departs from a range in which the display 14 is capable of displaying the photograph can be displayed through an upper and lower scroll operation by the user, for example. However, a display mode in which the virtual three-dimensional space has a perspective even in the vertical axis direction may be employed.

### (Concept of Coordinates in Virtual Three-Dimensional Space)

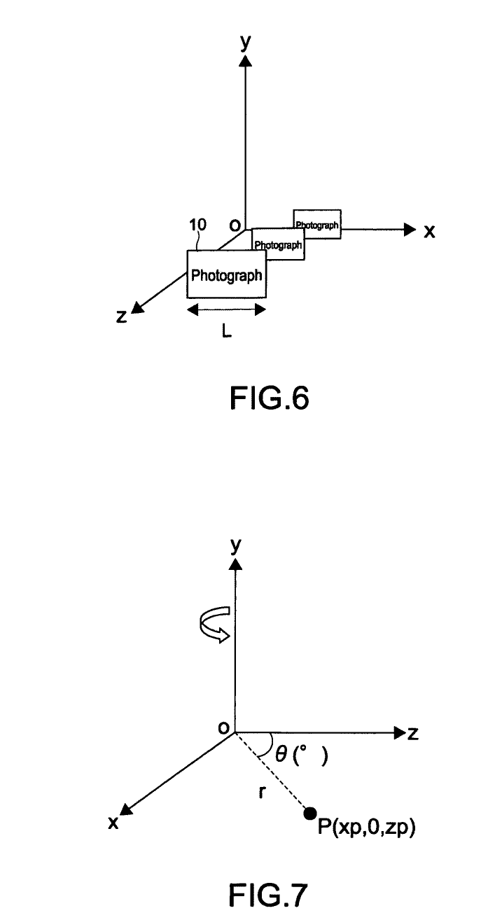

Now, the description will be made of a concept of coordinates in the virtual three-dimensional space. FIG. 6 is an explanatory view for coordinate axes of the virtual three-dimensional space and the size of each of photographs arranged on the coordinate axes. Further, FIG. 7 is an explanatory view for a method of specifying a position in which a photograph is arranged in the virtual three-dimensional space.

As shown in FIG. 6, the virtual three-dimensional space in this embodiment includes an x-axis (horizontal axis), a y-axis (vertical axis), and the z-axis (depth axis). As described above, in the first display mode of the virtual three-dimensional space, the x-axis is used for representing the azimuth direction, the y-axis is used for representing the altitude, and the z-axis is used for representing the time. In the second display mode, the x-axis is used for representing the azimuth direction, the y-axis is used for representing the time, and the z-axis is used for representing the distance.

Provided that the number of pixels in a smaller side of the photograph 10 is indicated by PIX, a length L of a larger side of the photograph 10 drawn in the virtual three-dimensional space is calculated by the following expression. A length of the smaller side of the photograph 10 is calculated based on an aspect ratio of the photograph 10.

L=α·PIX (α is a constant)

As shown in FIG. 7, the portable terminal 100 sets a point of the origin in the virtual three-dimensional space to “o.” The current location of the portable terminal 100 is set at the point of the origin. Further, the portable terminal 100 sets, when the azimuth direction is indicated by θ(°) as the photograph 10 is seen from the point of the origin o, a rotating frame is set in such a manner that θ=0(°) is in a direction of the z-axis. A value of θ(°) is set to be positive in a clockwise direction about the y-axis.

Here, provided that a position of the photograph 10 existing at the azimuth direction θ(°), a distance r from the portable terminal 100 is indicated by “P”, a coordinate P(xp,yp,zp)=(r cos θ,0,r sin θ) is established. As described above, a y-coordinate of the photograph 10 is converted based on the altitude of the photograph in a case where a piece of data of the altitude is obtained from the photograph in the first display mode. Meanwhile, in the second display mode, the y-coordinate of the photograph 10 is converted based on a time interval between the current date and time and the shooting date and time of the photograph 10.

### [Calculation Method of Size of Photograph]

Now, the description will be made of a calculation method of a size of each of the photographs to be drawn in the virtual three-dimensional space. In this embodiment, two calculation methods are used. The portable terminal 100 is capable of switching and using the two calculation methods, for example, according to instructions from the user during the time when the photograph-displaying application is being executed. In this manner, the portable terminal 100 is capable of drawing the virtual three-dimensional space.

### (First Calculation Method of Size of Photograph)

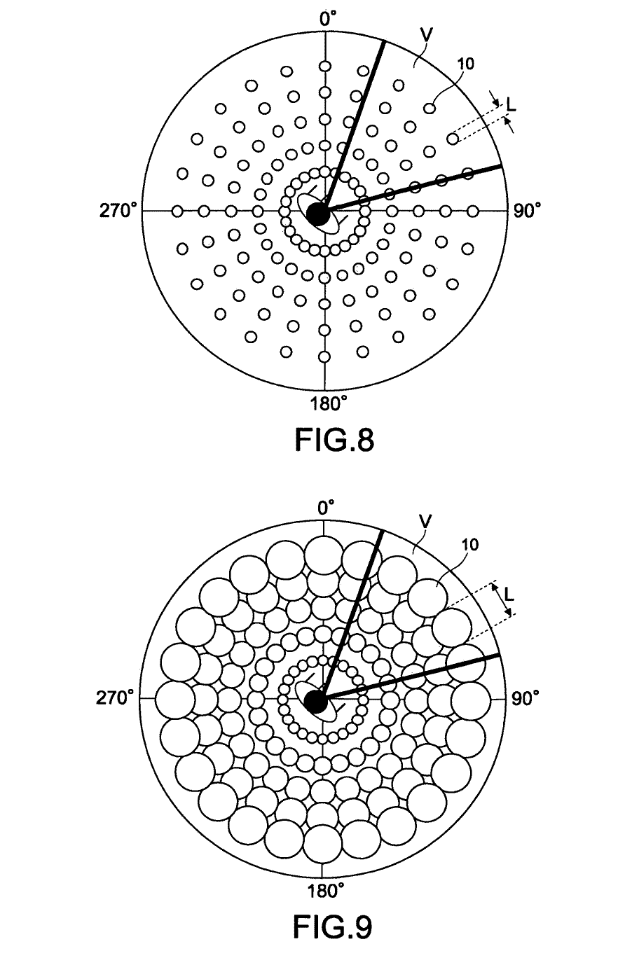

FIG. 8 is an explanatory view for a first calculation method for the size of the photograph. FIG. 9 is an explanatory view for a second calculation method for the size of the photograph. In both of FIG. 8 and FIG. 9, the virtual three-dimensional space shown in FIG. 2 and FIG. 4 is seen in a direction of the y-axis. In each of FIG. 2 and FIG. 4, an image of an eye, which is positioned at a center of a circle, indicates the view-point. Further, each photograph 10 of the photographs arranged within the circle is shown by the white circle in FIG. 2 and FIG. 4. That is, a position of the white circle indicates the position of a photograph, and the diameter of the white circle indicates the size of the photograph.

As shown in FIG. 8, the first calculation method is a method of arranging the photograph 10 at an azimuth direction θ, a distance r so as to have a constant size L. Specifically, in a case where the photograph 10 is positioned at the distance r, an azimuth direction angle θ(°) from the view-point, the portable terminal 100 draws the photograph 10 with the size L at a coordinate P(xp,yp,zp)=(r cos θ,0,r sin θ). In this case, when the virtual three-dimensional space is transparently translated into a two-dimensional image in a field of view V from the view-point, as the distance r becomes smaller, the photograph 10 is displayed with a larger size, and as the distance r becomes larger, the photograph 10 is displayed with a smaller size.

### (Second Calculation Method of Size of Photograph)

As shown in FIG. 9, the second calculation method is a method of arranging the photograph 10 at the azimuth direction θ, the distance r, in such a manner that a size of the photograph 10 becomes larger as the distance r becomes larger. Specifically, in a case where the photograph 10 is positioned at the distance r, the azimuth direction θ(°) from the view-point, the portable terminal 100 draws the photograph with a size of Lβr (β is a constant) in the coordinate P(xp,yp,zp)=(r cos θ,0,r sin θ). That is, the size of the photograph 10 increases in proportion to the distance r. In this case, when the virtual three-dimensional space is transparently translated into a two-dimensional image in the field of view V from the view-point, any photographs 10 are displayed with substantially the same size irrespective of the distance r. That is because a magnification ratio in the depth direction within the virtual three-dimensional space is substantially equal to the reciprocal of a reduction ratio of the photograph 10 in the depth direction in the transparent translation.

[Conversion Method for Shooting Date and Time of Photograph into Distance]

Now, the description will be made of a method of conversing the shooting date and time of the photograph into the distance (depth) in the first display mode of the virtual three-dimensional space. In this embodiment, two conversion methods are used. The portable terminal 100 is capable of switching and using the two conversion methods, automatically or according to the instructions from the user during the time when the photograph-displaying application is being executed. In this manner, the portable terminal 100 is capable of drawing the virtual three-dimensional space. That is, the portable terminal 100 is capable of selectively performing a first mode and a second mode. In the first mode, the portable terminal 100 uses a first conversion method to draw the virtual three-dimensional space. In the second mode, the portable terminal 100 uses a second conversion method to draw the virtual three-dimensional space. A specific determination method in the selection process will be described later.

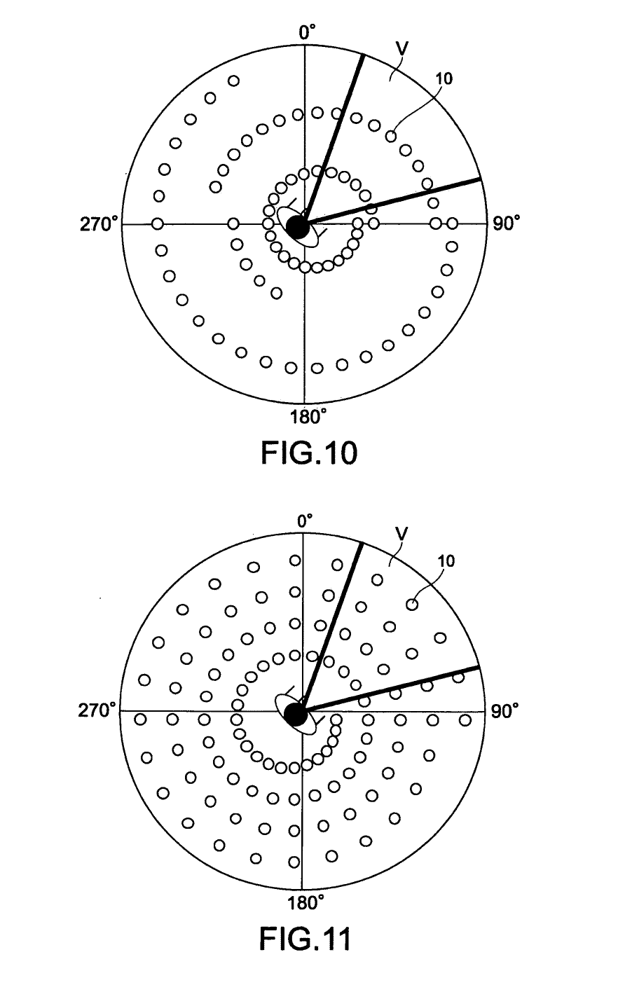

FIG. 10 is an explanatory view for the first conversion method for the shooting date and time into the distance. FIG. 11 is an explanatory view for the second conversion method for the shooting date and time into the distance. In both of FIG. 10 and FIG. 11, similarly to FIG. 8 and FIG. 9, the virtual three-dimensional space is seen in the direction of the y-axis. In each of FIG. 10 and FIG. 11, an image of an eye, which is positioned at a center of a circle indicates the view-point. Further, each photograph 10 of the photographs arranged within the circle is indicated by “o”.

(First Conversion Method for Shooting Date and Time into Distance)

As shown in FIG. 10, the first conversion method (first mode) is a method in which a shooting date and time t of the photograph 10 and a distance r into which the shooting date and time t is converted correspond to each other in a ratio of 1:1.

In a shooting order according to the shooting date and time of each of photographs, the photographs 10 are respectively indicated by P1, P2, P3 . . . , the shooting date and time thereof are respectively indicated by t1, t2, t3 . . . (t1<t2<t3 . . . ), and a distance between the portable terminal 100 and each photograph 10 is arranged indicated by r1, r2, r3 . . . . In this case, the distance r is calculated by the following expression.

r1=γt1, r2=γt2, r3=γt3, . . .

(γ is a constant for converting the shooting date and time into the distance)

In the conversion method, the shooting date and time t of the photograph 10 and the distance r between the portable terminal 100 and the arranged photograph 10 correspond to each other at a ratio of 1 to 1. Thus, the user can intuitively grasp an interval between a shooting date and time and another shooting date and time of photographs 10 through viewing the distance between the arranged photographs 10. For example, a plurality of photographs 10, which have been shot intensively in a certain time band at a certain day, are displayed collectively at a certain position, and a photograph 10, which has been shot a week earlier, is displayed at a position significantly far away from the collectively displayed photographs described above.

(Second Conversion Method for Shooting Date and Time into Distance)

As shown in FIG. 11, the second conversion method (second mode) is a method in which a distance r in a case of conversing a shooting date and time t of the photograph 10 into a distance is determined by not the shooting date and time t, but a shooting order.

That is, as described above with reference to FIG. 10, according to the shooting order of the photographs, the photographs 10 are respectively indicated by P1, P2, P3 . . . , each shooting date and time thereof is respectively indicated by t1, t2, t3 . . . (t1<t2<t3 . . . ), and a distance of photographs 10 is indicated by r1, r2, r3 . . . . In this case, the distance r is calculated by the following expression.

r1=κt1, r2=r1+κ, r3=r2+κ, . . .

(κ is a constant indicating a distance interval between a certain photograph and a subsequently shot photograph)

In the conversion method, even in a case where there is variety in the length of the interval between a shooting date and time and another a shooting date and time of the photographs 10, the photographs 10 are arranged in the virtual three-dimensional space with a good balance (without concentration of density of photographs), and hence the virtual three-dimensional space is efficiently used. Further, although it is difficult for the user to grasp the shooting date and time of the photograph, the user can intuitively grasp the shooting order. Further, the user can check even a photograph shot at a very old shooting date and time as easily as a photograph shot at a very late shooting date and time.

### [Operation of Portable Terminal]

Now, the description will be made of an operation of the portable terminal 100 configured in the above-mentioned manner. In the following, although the description will be made on the assumption that the CPU 11 of the portable terminal 100 is one that mainly performs the operation, the operation is actually performed in cooperation with the photograph-displaying application and other programs, which are executed under a control of the CPU.

### (Display Process Procedures According to First Display Mode of Virtual Three-Dimensional Space)

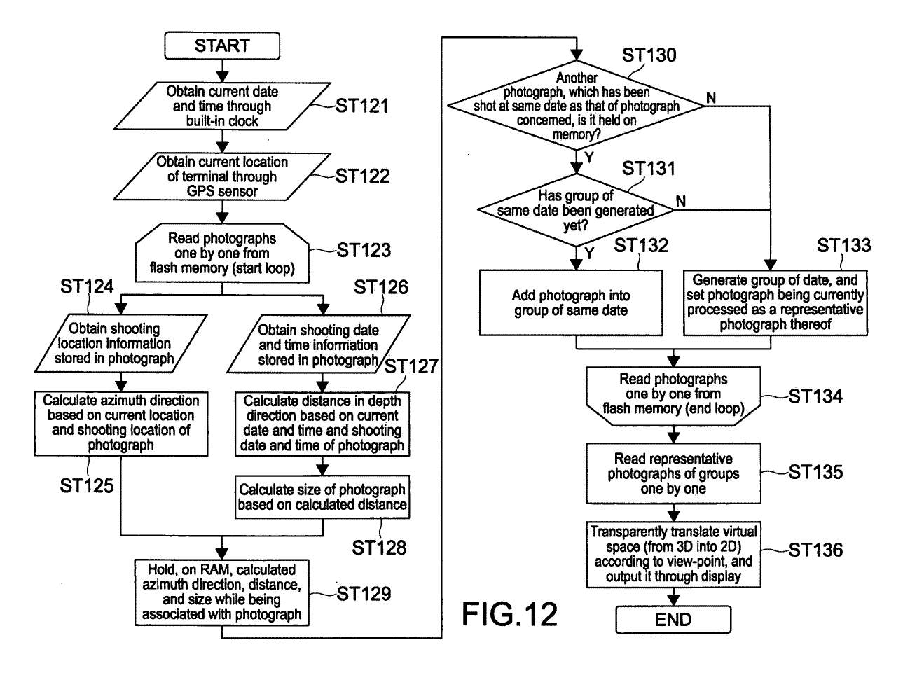

FIG. 12 is a flowchart of display processes according to the first display mode of the virtual three-dimensional space shown in FIG. 2 and FIG. 3.

As shown in FIG. 12, the CPU 11 of the portable terminal 100 first obtains the current date and time through the built-in clock (Step 121). Subsequently, the CPU 11 of the portable terminal 100 obtains the current location of the portable terminal 100 through the GPS sensor 23 (Step 122).

Subsequently, the CPU 11 reads the photographs one by one from the flash memory 13, and starts a loop process with respect to each of the photographs (Step 123). In the loop process, the CPU 11 obtains the shooting location information stored in the photograph (Step 124). Then, based on the current location and the shooting location information of the photograph, the azimuth direction of the photograph is calculated (Step 125). Further, the CPU 11 obtains the shooting date and time information stored in the photograph (Step 126). Then, the CPU 11 calculates, based on the current date and time and the shooting date and time information of the photograph, a distance in the depth direction (Step 127). In addition, the CPU 11 calculates the size of the photograph based on the calculated distance in the depth direction according to a currently selected calculation method of the first calculation method and the second calculation method as described above with reference to FIG. 8 and FIG. 9 (Step 128).

Subsequently, the CPU 11 holds on the RAM 12 the azimuth direction, the distance, and the size, which are thus calculated while being associated with the photograph (Step 129). Here, in a case where the information of the altitude can be obtained from the photograph, the CPU 11 calculates, based on the current location and the altitude, a position in the y-axis of the photograph, and holds on the RAM 12 the position together with the azimuth direction, the distance, and the size while being associated with the photograph.

Subsequently, the CPU 11 determines whether or not another photograph, which has been shot at the same date as that of the photograph being currently processed in the loop process, is held on the RAM 12 (Step 130). In a case where it is determined that another photograph, which has been shot at the same date as that of the photograph being currently processed in the loop process, is held on the RAM 12 (Yes), the CPU 11 determines whether or not a group of the same date has already been generated (Step 131). It is determined that the group of the same date has already been generated (Yes), the CPU 11 adds, in the group of the same date, another photograph, which has been shot at the same date as that of the photograph being currently processed in the loop process (Step 132).

In a case where it is determined in Step 130 that another photograph, which has been shot at the same date as that of the photograph being currently processed in the loop process, is not held on the RAM 12 (No), and in a case where it is determined in Step 131 that the group of the same date has not yet been generated (No), the CPU 11 generates a new group of the above-mentioned date, and sets the photograph being currently processed as a representative photograph of that group (Step 133).

The CPU 11 repeats the above-mentioned loop process with respect to all photographs stored in the flash memory 13 (Step 134).

Then, the CPU 11 reads the representative photographs of each group, which are thus generated, one by one (Step 135). Further, the CPU 11 outputs the virtual three-dimensional space in which the photographs are drawn in such a manner that each of the photographs is arranged at a position corresponding to the azimuth direction, the distance, and the size, which are held on the RAM 12, generates a two-dimensional image through transparently translating the three dimensional into the two-dimensional according to the current view-point, and outputs the two-dimensional image through the display 14 (Step 136).

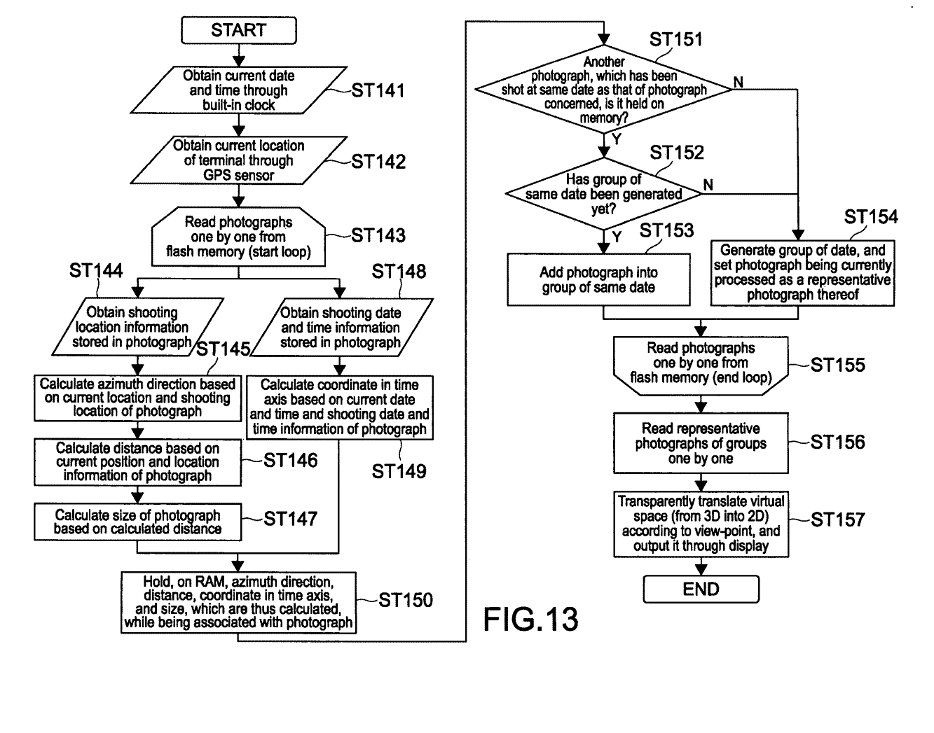

In a case where an operation of switching between the first display mode and the second display mode is input after the image of the virtual three-dimensional space in the first display mode is displayed, the CPU 11 performs processes shown in FIG. 12 or FIG. 13, to thereby redraw the virtual three-dimensional space in different display mode, and outputs the image thereof. Similarly, also in a case where an operation of switching between the first calculation method and the second calculation method of the size of the photograph is input, the CPU 11 recalculates the size of the photograph by the expression described above with reference to FIG. 8 or FIG. 9, redraws the virtual three-dimensional space, and outputs the image thereof.

### (Display Process Procedures According to Second Display Mode of Virtual Three-Dimensional Space)

FIG. 13 is a flowchart of display processes according to the second display mode of the virtual three-dimensional space shown in FIG. 4 and FIG. 5.

As shown in FIG. 13, the CPU 11 first performs the same processes as the processes in Step 121 and Step 122 in the first display mode described above with reference to FIG. 12 (Step 141 and Step 142).

Subsequently, the CPU 11 reads the photographs from the flash memory 13 one by one, and starts a loop process with respect to each of the photographs (Step 143). In the loop process, the CPU 11 calculates, as described above with reference to Step 124 and Step 125 of FIG. 12, based on the current location and the shooting location information of the photograph, an azimuth direction of the photograph (Step 144 and Step 145). In addition, the CPU 11 calculates, based on the current location and the shooting location information of the photograph, a distance in the depth direction (Step 146). Further, based on the above-mentioned distance, the CPU 11 calculates the size of the photograph according to a currently selected calculation method of the first calculation method and the second calculation method described above with reference to FIG. 8 and FIG. 9 (Step 147).

Meanwhile, the CPU 11 obtains the shooting date and time information stored in the photograph (Step 148). Further, the CPU 11 calculates, based on the current date and time and the shooting date and time information of the photograph, a coordinate of the photograph in the time axis (y-axis) (Step 149).

Subsequently, the CPU 11 holds on the RAM 12 the azimuth direction, the distance, the size, and the coordinate in the time axis, which are thus calculated, while being associated with the photograph (Step 150).

After that, the CPU 11 generates a group with respect to each of the photographs as described above with reference to Step 130 to Step 136 of FIG. 12, translates, into a two-dimensional image, the virtual three-dimensional space in which the representative photograph of each of the groups is arranged at a position corresponding to the azimuth direction, the distance, and the coordinate in the time axis, which are held on the RAM 12, and outputs the two-dimensional image through the display 14 (Step 136) (Step 151 to Step 157).

Also after the image of the virtual three-dimensional space in the second display mode is displayed, the CPU 11 redraws the virtual three-dimensional space according to an instruction of switching the display mode of the virtual three-dimensional space and the calculation method, and outputs the image.

[Automatic Switching Processes of Conversion Method for Shooting Date and Time into Distance of Photograph]

As described above, in this embodiment, the portable terminal 100 is capable of automatically selecting the first conversion method and the second conversion method for the shooting date and time into the distance of the photograph during the time when the photograph-displaying application is being executed. In the following, the automatic selection process will be described.

As assumption of the automatic selection process, it is assumed that the shooting date and time of an n-th shot photograph is indicated by t[n], and the shooting date and time of a first shot photograph (n=1) is set to t[1]=0 (second). Further, a constant γ used in the first conversion method for the shooting date and time into the distance is indicated by γ=1. In addition, the shooting date and time of the photograph shot at a certain time is set to t[n], and the shooting date and time of the photograph subsequently shot is indicated by t[n+1].

In this case, provided that an interval between a shooting date and time and another shooting date and time of the both photographs is indicated by diff[n], diff[n] is calculated by the following Expression (1).

diff[n]=t[n+1]−t[n] Expression (1)

Further, provided that an arithmetic average of the interval of the shooting date and time is indicated by diffAve, and the sum number of photographs is indicated by N, diffAve is calculated by the following Expression (2).

diffAve=Σdiff/(N−1) Expression (2)

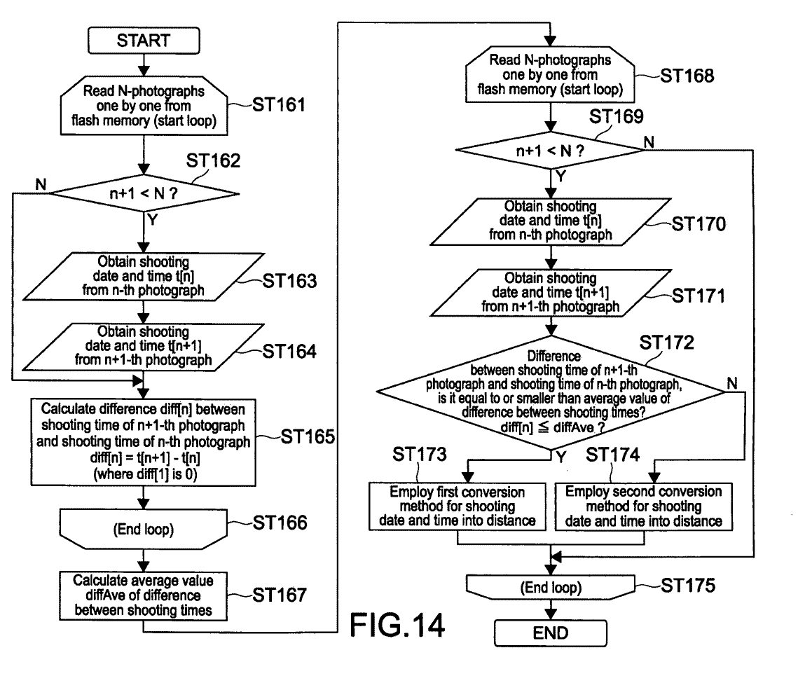

FIG. 14 is a flowchart of automatic switching processes between the first conversion method and the second conversion method for the shooting date and time into the distance of the photograph. The process is performed before the processes described above with reference to FIG. 12 and FIG. 13, for example. However, the process may be performed in the middle way of each process, for example, after Step 126 of FIG. 12, after Step 148 of FIG. 13, or the like.

As shown in FIG. 14, the CPU 11 reads N-photographs in the flash memory 13 one by one, and starts a first loop process (Step 161). In the first loop process, the CPU 11 determines whether or not a number obtained by adding an order number n of the read photographs with 1 is smaller than the sum number N of photographs (Step 162).

In a case where n+1<N is established (Yes), the CPU obtains the shooting date and time t[n] from an n-th photograph (Step 163). Further, the CPU 11 obtains the shooting date and time t[n+1] from an n+1-th photograph (Step 164).

Subsequently, the CPU 11 calculates a difference diff[n] between a shooting time of the n+1-th photograph and a shooting time of the n-th photograph by the above-mentioned Expression (1) (Step 165).

The CPU 11 repeats the above-mentioned first loop process until n+1=N is obtained (Step 166).

Subsequently, the CPU 11 calculates an average value diffAve of the difference between the shooting times by the above-mentioned Expression (2) (Step 167).

Subsequently, the CPU 11 rereads the n photographs (“n” refers to number of photographs) in the flash memory 13, and starts a second loop process (Step 168). In the second loop process, the CPU 11 obtains t[n] and t[n+1] similarly to Step 163 and Step 164 in the above-mentioned first loop process (Step 170, Step 171).

Subsequently, the CPU 11 determines whether or not the difference diff[n] between the shooting time of the n+1-th photograph and the shooting time of the n-th photograph is equal to or smaller than the average value diffAve of the difference between the shooting times thus calculated (Step 172).

In a case where it is determined that diff[n]≦diffAve is established (Yes), then the CPU 11 employs the first conversion method for the shooting date and time into the distance with respect to the n-th photograph and the n+1-th photograph (Step 173). In a case where it is determined that diff[n]>diffAve is established (No), then the CPU 11 employs the second conversion method for the shooting date and time into the distance with respect to the n-th photograph and the n+1-th photograph (Step 174). In the case where the second conversion method is employed, the above-mentioned constant κ is set to κ=diffAve.

The CPU 11 repeats the above-mentioned second loop process until n+1=N is obtained (Step 175), and selects the conversion method for the shooting time into the distance with respect to all the N-photographs before terminates the process.

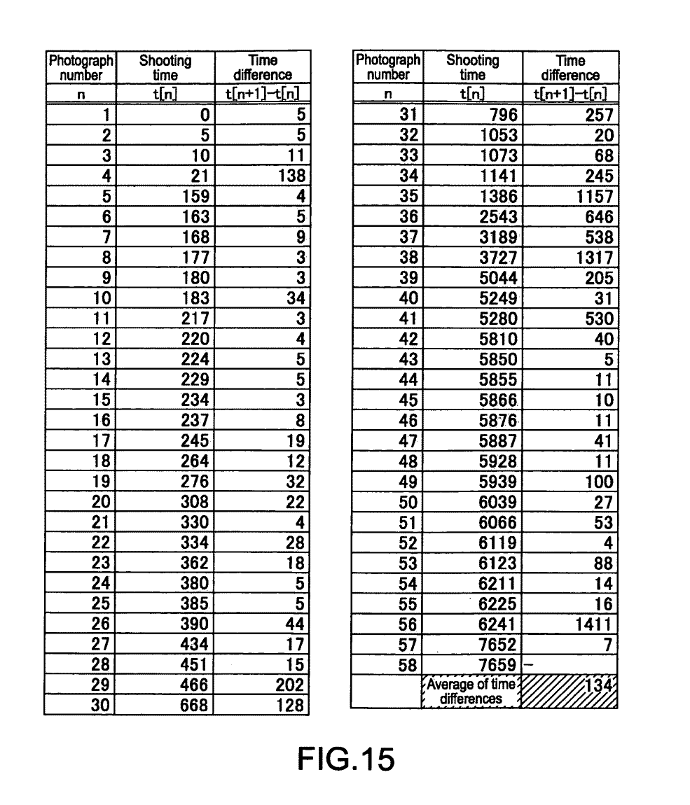

FIG. 15 is a table showing an elapsed time t[n] since a first image of actually shot photographs has been shot and a shooting interval diff[n]=t[n+1]−t[n]. As shown in FIG. 15, an average shooting interval diffAve is 134 (seconds).

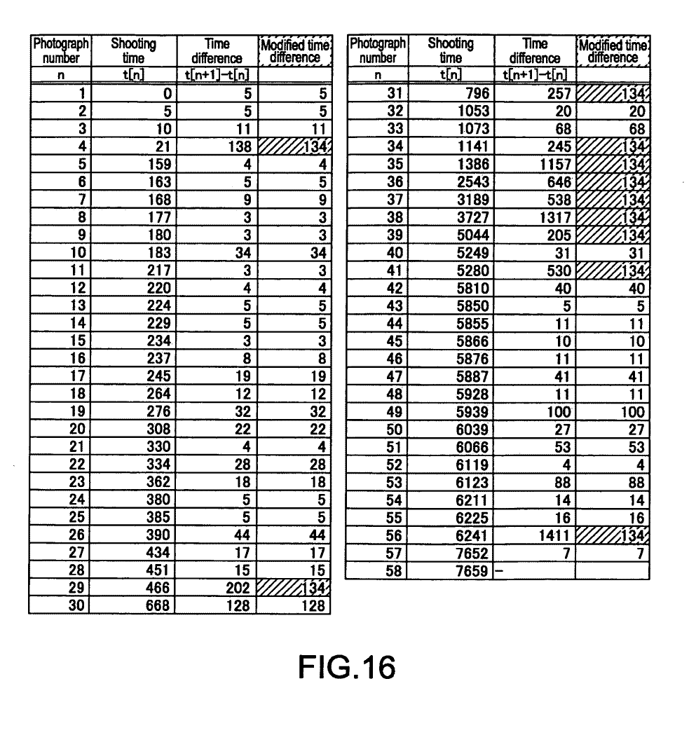

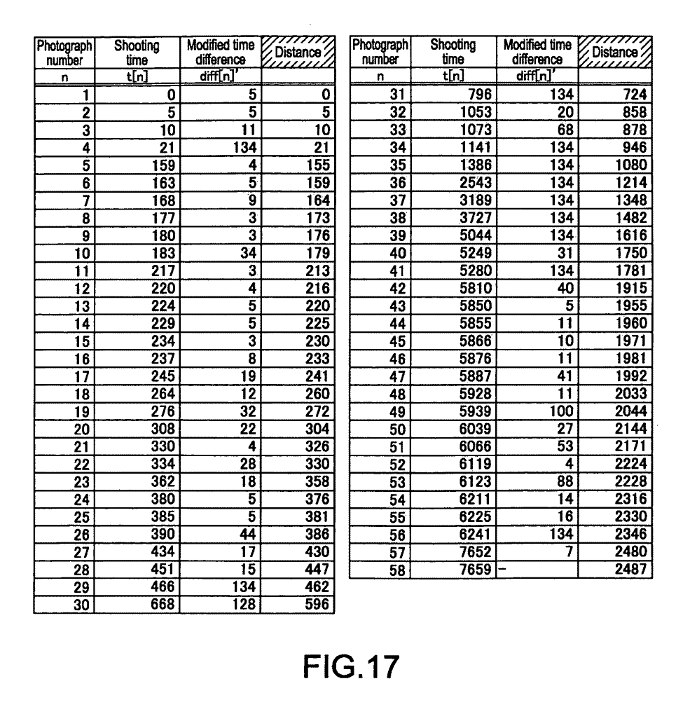

FIG. 16 is a view in which an ideal value of the time difference of each of the photographs after processed in the automatic selection process in FIG. 15 is shown as a modified time difference. As shown in FIG. 16, provided that the modified time difference is indicated by diff[n]′, in a case where diff[n]≦diffAve is established, the modified time difference diff[n]′=γdiff[n] is obtained according to the first conversion method for the shooting date and time into the distance, and diff[n]′=diff[n] is obtained due to γ=1. Meanwhile, in a case where Diff[n]>diffAve is established, the modified time difference diff[n]′=κ is obtained according to the second conversion method for the shooting date and time into the distance, and diff[n]′=diffAve is obtained due to κ=diffAve. FIG. 17 is a table showing a result of calculating the distance from the view-point to a position at which each of the photographs have to be arranged in the virtual three-dimensional space through performing a process according to the method shown in FIG. 16.

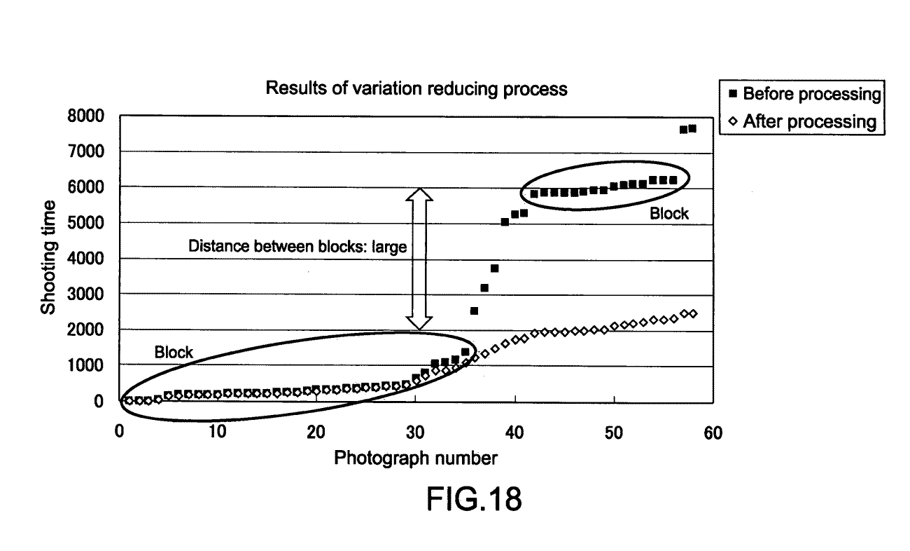

Further, in this embodiment, as described above, γ=1 (that is, it can be said that when shooting time interval between photographs is 1 second, the photographs are arranged with a distance interval of 1 cm) is set, and hence the shooting time and the calculated distance can correspond to each other. FIG. 18 is a graph showing a result before the automatic selection process and a result after the automatic selection process. In FIG. 18, each of pieces of actual data before the automatic selection process of the conversion method for the shooting date and time into the distance is shown by the black square of the drawing, and each of pieces of data after the automatic selection process is shown by the white diamond of the drawing.

As shown in FIG. 17, before the automatic selection process, two blocks of time bands in which photographs are frequently shot (shooting interval between the photographs is small) exists, and the interval of the shooting date and time between those blocks is large. In this case, when the shooting time is translated into the distance, the distance between the blocks is long, that is, a low density portion (or blank portion) is generated.

Meanwhile, after the automatic selection process, the interval of the blocks is shortened. Thus, it can be seen that the photographs are arranged in the limited virtual three-dimensional space without concentration of the density, and that the space is efficiently used.

### [Output Example of Virtual Three-Dimensional Space]

Now, the description will be made of an actual output example of the virtual three-dimensional space to be output to the display 14 according to the above-mentioned processes.

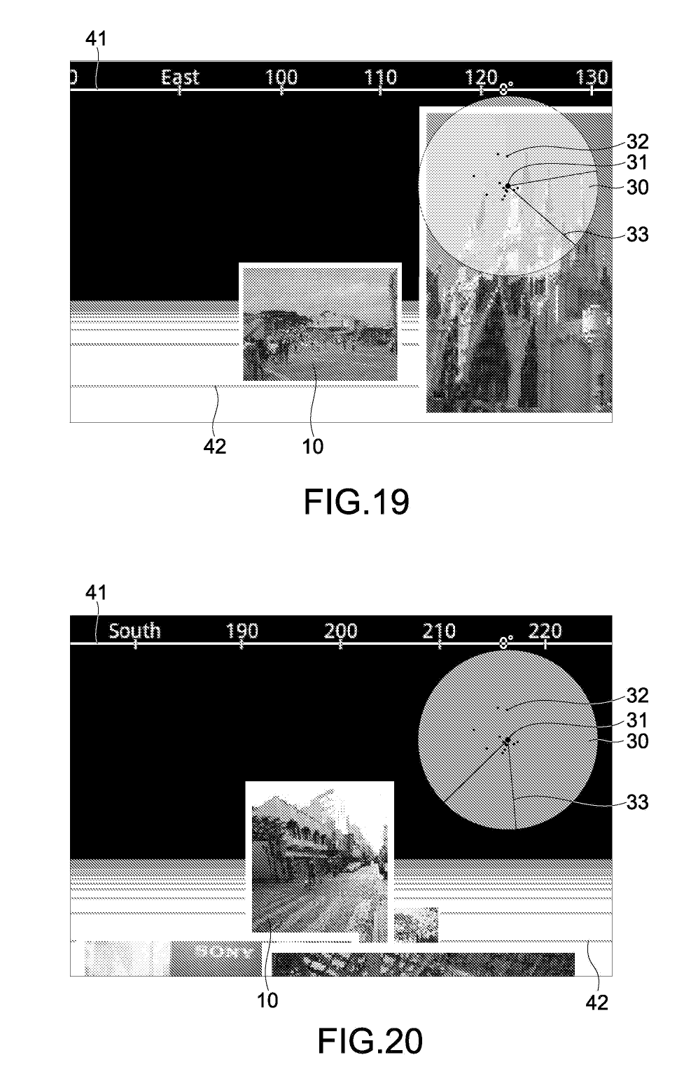

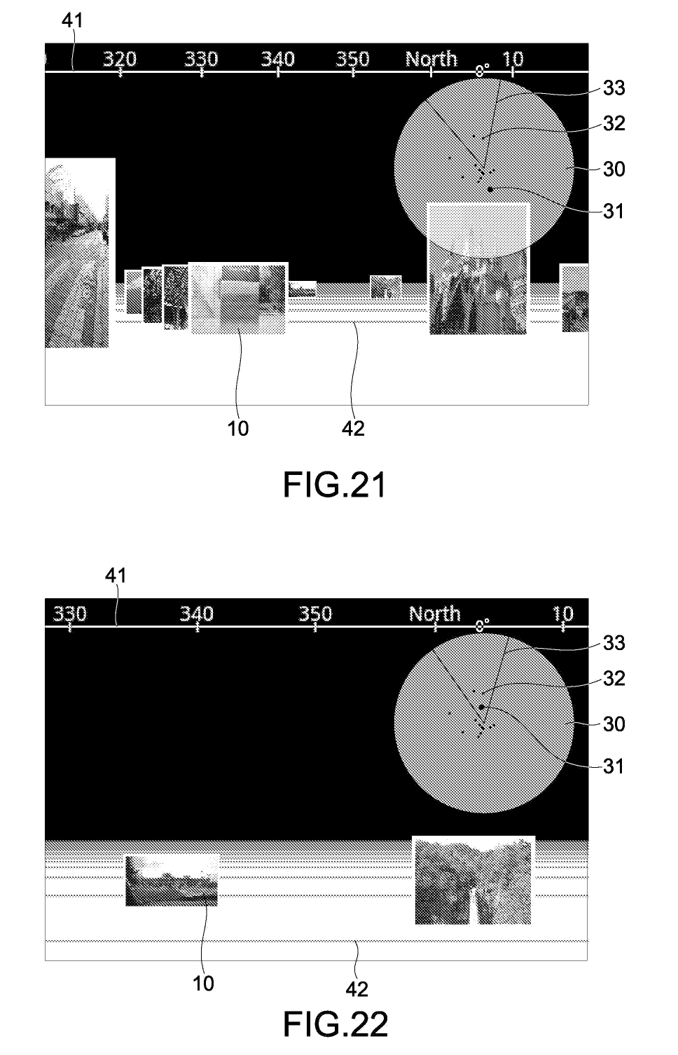

FIG. 19, FIG. 20, FIG. 21, and FIG. 22 are views showing output examples in a case where the first display mode of the virtual three-dimensional space, the first calculation method of the size of the photograph, and the first conversion method for the shooting date and time into the distance are employed, respectively.

In those drawings, FIG. 19 is an output example in a case where the portable terminal 100 is oriented to the azimuth direction of the east. FIG. 20 is an output example in a case where the portable terminal 100 is oriented to the azimuth direction of the south. As shown in FIG. 19 and FIG. 20, the output image of the virtual three-dimensional space includes, in addition to the images of the photographs 10, an overhead-view navigation image 30, a number line image 41, and a horizontal line image 42.

The overhead-view navigation image 30 shows the virtual three-dimensional space overhead-viewed from the direction of the y-axis. The overhead-view navigation image includes a view-point displaying point 31, position displaying points 32, and view-range displaying lines 33. The view-point displaying point 31 indicates a view-point. Each of position displaying points 32 indicates a drawing position of each of the photographs 10. The view-range displaying lines indicate a view range from the view-point. With the overhead-view navigation image 30, the user can intuitively grasp a position in the entire virtual three-dimensional space and a current range of a field of view of the user, while the user is locally viewing each of the photographs per the azimuth direction and per a time.

The number line image 41 indicates the azimuth direction angle corresponding to the above-mentioned range of the field of view. At positions respectively corresponding to azimuth direction angles of 0° (360°), 90°, 180°, and 270°, characters referring to the azimuth directions such as North, East, South, and West are indicated instead of the azimuth direction angles. With this, the user can easily and correctly grasp which azimuth direction the current range of the field of view of the user corresponds to.

The portable terminal 100 is capable of switching between display and non-display of the overhead-view navigation image 30, the number line image 41, and the horizontal line image 42 according to a choice of the user.

As described above, in the first display mode of the virtual three-dimensional space, the photograph 10 is displayed to have a smaller size as the distance of the photograph 10 in the depth direction from the view point becomes larger.

In this embodiment, the portable terminal 100 is capable of moving the position of the view-point in the virtual three-dimensional space to a position being far away from the center, for example, according to the operation by the user. FIG. 21 and FIG. 22 are views each showing the output example in a case where the view-point is moved from the center.

FIG. 21 is the output example in a case where the view-point is backwardly moved (zoomed out) in a state in which the portable terminal 100 is oriented to the azimuth direction of North. FIG. 22 is the output example in a case where the view-point is forwardly moved (zoomed in) in a state in which the portable terminal 100 is similarly oriented to the azimuth direction of North. As shown in both of FIG. 21 and FIG. 22, along with the movement of the view-point, the view-point displaying point 31 in the overhead-view navigation image 30 is also moved. With this, the user can intuitively grasp whether the user has performed a zoom-in operation or a zoom-out operation.

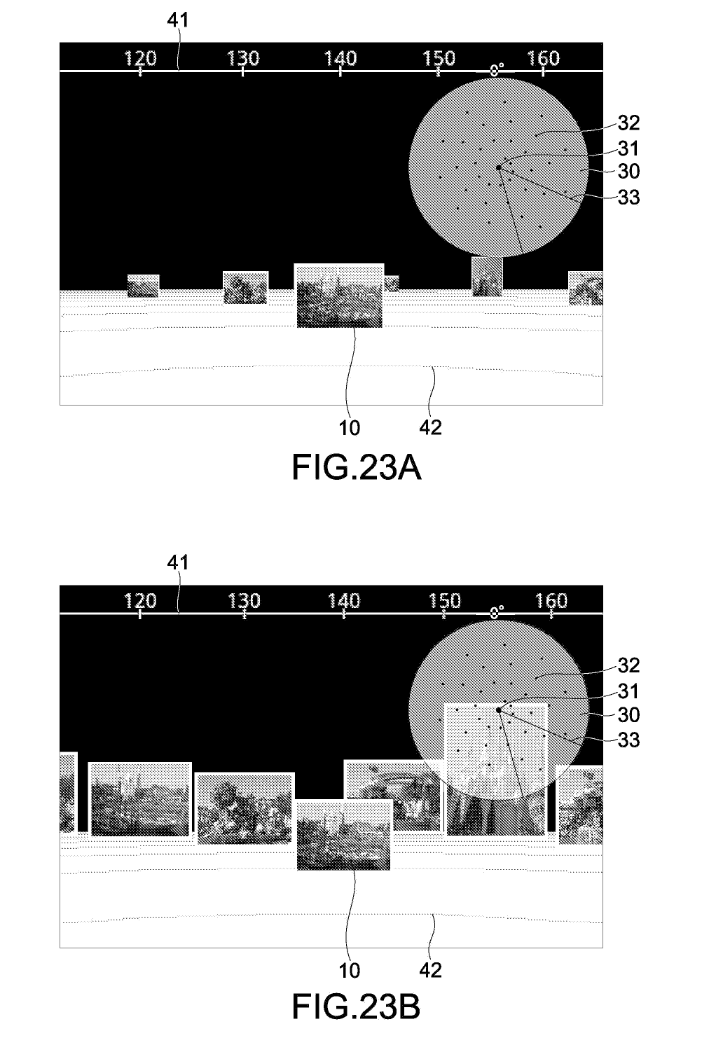

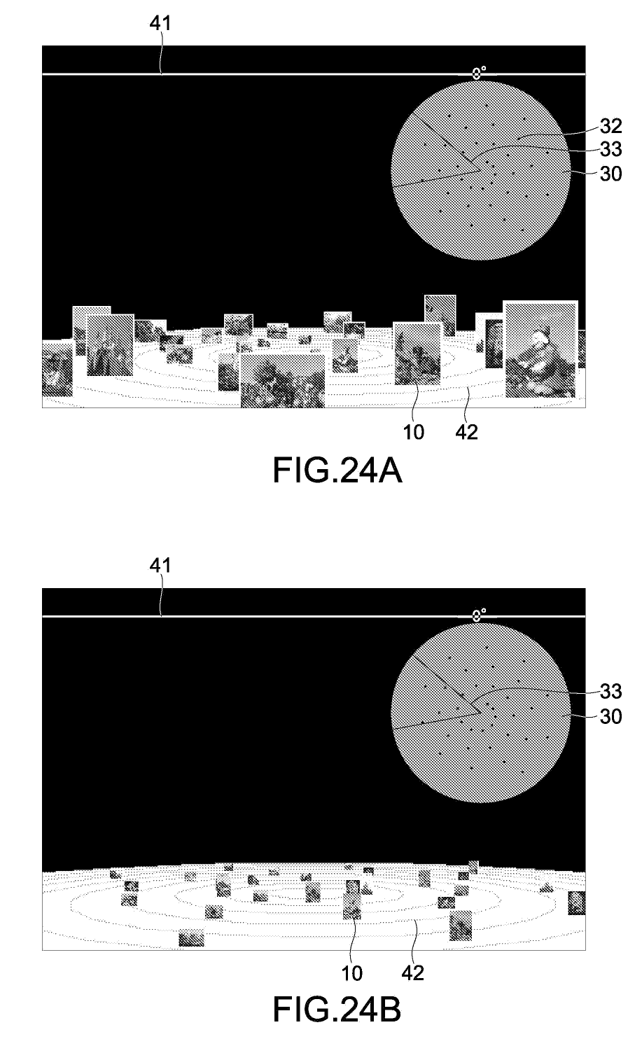

FIG. 23 and FIG. 24 show output examples in a case where the first display mode of the virtual three-dimensional space and the second conversion method for the shooting date and time into the distance are employed, as a case where the first calculation method of the size of the photograph is employed is compared to a case where the second calculation method of the size of the photograph is employed.

FIG. 23(A) is the output example in a case of using the first calculation method of the size of the photograph. FIG. 23(B) is the output example in a case of using the second calculation method of the size of the photograph with respect to the same photograph as that in FIG. 23(A). Further, in this embodiment, the portable terminal 100 is also capable of displaying, for example, according to the operation by the user, a wide-angle image shot in such a state that the entire virtual three-dimensional space is captured from the above slightly. FIG. 24 show the output examples of the above-mentioned wide-angle images. FIG. 24(A) is the output example in a case of using the first calculation method of the size of the photograph with respect to the above-mentioned wide-angle image. FIG. 24(B) is the output example in a case of using the second calculation method of the size of the photograph with respect to the wide-angle image of the same photograph as that in FIG. 24(A).

As shown in those drawings, the second conversion method for the shooting date and time into the distance is used, and hence, as compared to the output example according to the first conversion method shown in FIG. 19 to FIG. 21, the photographs are arranged with good balance in the virtual three-dimensional space, and the space is efficiently used. Here, the position displaying points 32 are arranged so as to draw a helical form from the center. That is because those photographs are shot at predetermined intervals while a pan is performed at a constant speed through a party shot function as will be described later.

Further, although not shown, the portable terminal 100 is also capable of displaying, as well as the photograph (for example, in vicinity of photograph 10), the shooting date and time thereof according to the choice by the user. Thus, even in a case where the second conversion method for the shooting date and time into the distance is employed, and the position of the photograph does not correspond to the shooting date and time in a ratio of 1:1, the user can grasp the shooting date and time.

Further, in comparison with each of FIG. 23A and FIG. 24A of the cases of using the first calculation method of the size of the photograph, as shown in each of FIG. 23B and FIG. 24B, the second calculation method of the size of the photograph is used, and hence any photographs are displayed so as to have substantially the same size irrespective of the distance from the view-point. With this, distant photographs are displayed so as to have the same size as that of near photographs, and hence it becomes easier for the user to confirm the photographs and to perform the choice operation.

### [Conclusion]

As described above, according to this embodiment, the portable terminal 100 enables the shooting date and time of the photograph and the shooting location to be intuitively grasped in the virtual three-dimensional space. Further, by use of the second calculation method of the size of the photograph and the second conversion method for the shooting date and time into the distance, the portable terminal 100 is capable of efficiently using the virtual three-dimensional space and improving, at the same time, convenience in viewing the photographs and operability.

### [Modifications]

Embodiments according to the present invention are not limited to the above-mentioned embodiment, and can be variously modified without departing from the gist of the present invention.

Although in the first display mode in the above-mentioned embodiment, the portable terminal 100 indicates the altitude in the y-axis of the virtual three-dimensional space in a case where the pieces of data of the altitude are obtained from the photographs, the portable terminal 100 may indicate a tilt angle of each of the photographs in the y-axis in place of the altitude.

Assumed is a case where the portable terminal 100 is, for example, at a gathering such as a party, capable of performing a function (party shot function) of detecting the faces of a subjects through automatically performing a pan, a tilt, and a zoom, determining a composition of the photograph and a timing, and then automatically shooting an image. The above-mentioned function is realized when the portable terminal 100 is connected to an electronic camera platform having an automatic follow-up function for each of motion of the pan, the tilt, and the zoom, and the faces, for example.

The portable terminal 100 is set to be capable of performing a mode (party shot photograph display mode) of displaying photographs, which are shot through the party shot function, in the virtual three-dimensional space other than a normal mode of displaying photographs in the virtual three-dimensional space. When the party shot function is performed, the portable terminal 100 stores at least tilt angle information at a time of shooting an image. Then, in the party shot photograph display mode, the portable terminal 100 determines a coordinate in the y-axis of a photograph in the virtual three-dimensional space correspondingly to the stored tilt angle. With this, as compared to a photograph having a tilt angle of 0°, for example, a photograph having an upper tilt (shot from below) is displayed in a lower direction in the y-axis, and a photograph having a lower tilt (shot from above) is displayed in an upper direction in the y-axis.

Although in the above-mentioned embodiment, the portable terminal 100 displays only the representative images of the respective groups regarding the photographs each shot at the same date, the portable terminal 100 may display even all photographs each shot at the same date and time. Further, the portable terminal 100 may be set to be capable of selecting the display for each of group or the display for all photographs according to the operation by the user. Further, the portable terminal 100 may be set to display all photographs in a case where the number of photographs each shot at the same date and time is smaller than a predetermined number, and to display representative images for the respective groups in a case where the number of photographs each shot at the same date and time exceeds the predetermined number.

Although in the above-mentioned embodiment, objects to be drawn in respective corresponding positions in the virtual three-dimensional space are only photographs, buildings and nature objects, which can be land marks, including, for example, Mt. Fuji and Tokyo tower may be displayed together with the photograph. With this, it is possible to intuitively grasp the azimuth direction and the distance of each of the photographs. In order to perform the above-mentioned process, it is sufficient that the portable terminal 100 store three-dimensional map information including land marks in advance, or receive the three-dimensional map information including land marks from a predetermined place on network.

Although in the above embodiment, the example in which the present invention is applied to the portable terminal has been described, the present invention is applicable also to other electronic apparatuses including, for example, a notebook PC, a desktop PC, a server apparatus, a recording/reproducing apparatus, a digital still camera, a digital video camera, a television apparatus, a car navigation apparatus. In this case, if the imaged virtual three-dimensional space can be output to the outside display, the display not has to be provided in those apparatuses.

Further, photographs stored in another apparatus such as a server in the Internet may be drawn in the virtual three-dimensional space that another apparatus may be transmitted via a network to the portable terminal so as to be displayed. In this case, the current location information may be transmitted from the portable terminal to another apparatus, and this apparatus may draw the virtual three-dimensional space through using the current location information of the portable terminal as a reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus, comprising:
a storage configured to store
a plurality of digital photograph images,
shooting date and time information indicating a shooting date and time of each of the digital photograph images, and
shooting location information indicating a shooting location of each of the digital photograph images;
a current date and time obtaining unit configured to obtain a current date and time;
a current location obtaining unit configured to obtain a current location;
a controller configured to
draw each of digital photograph images at a drawing position based on the shooting date and time and the shooting location in a virtual three-dimensional space, the virtual three-dimensional space including
one of a time axis corresponding to the shooting date and time and a distance axis corresponding to the shooting location in a radial direction of a circle having a center at a view-point of a user, the view-point corresponding to the current date and time and the current location, and
a direction axis corresponding to the shooting location in a circumferential direction of the circle, each of digital photograph images being drawn in such a manner that each of digital photograph images has a size proportional to a distance from the view-point to the drawing position, and
image the virtual three-dimensional space, in which each of digital photograph images is drawn, for a predetermined range of field of view from the view-point; and
an output unit configured to output the imaged virtual three-dimensional space.

2. The electronic apparatus according to claim 1, wherein
the virtual three-dimensional space includes the time axis in the radial direction, and
the controller is capable of selectively performing
a first mode of drawing each of the digital photograph images in such a manner that a distance from the view-point to the drawing position of each of the digital photograph images on the time axis is proportional to the shooting date and time, and
a second mode of drawing each of the digital photograph images in such a manner that the distance from the view-point to the drawing position of each of the digital photograph images on the time axis is proportional to a shooting order of each of the digital photograph images, the shooting order being calculated based on the shooting date and time.

3. The electronic apparatus according to claim 2, wherein
the controller is configured
to determine whether or not an interval between a shooting date and time of a first image of the digital photograph images and another shooting date and time of a second image of the digital photograph images is equal to or smaller than a predetermined value, the first image and the second image being adjacent to each other in time sequence,
to perform the first mode when determined that the interval is equal to or smaller than the predetermined value, and
to perform the second mode when determined that the interval is larger than the predetermined value.

4. The electronic apparatus according to claim 1, wherein
the controller draws, in the virtual three-dimensional space imaged for the predetermined range of field of view, an overhead-view image indicating as an overhead-view a drawing position of each of the digital photograph images drawn in all directions, the view-point, and the range of the field of view.

5. The electronic apparatus according to claim 1, wherein
the controller draws, in the virtual three-dimensional space imaged for the predetermined range of field of view, a number line image indicating an angle of the direction, the angle corresponding to the range of the field of view.

6. An image output method, comprising:
storing
a plurality of digital photograph images,
shooting date and time information indicating a shooting date and time of each of the digital photograph images, and
shooting location information indicating a shooting location of each of the digital photograph images;
obtaining a current date and time;
obtaining a current location;
drawing each of digital photograph images at a
drawing position based on the shooting date and time and the shooting location in a virtual three-dimensional space, the virtual three-dimensional space including
one of a time axis corresponding to the shooting date and time and a distance axis corresponding to the shooting location in a radial direction of a circle having a center at a view-point of a user, the view-point corresponding to the current date and time and the current location, and
a direction axis corresponding to the shooting location in a circumferential direction of the circle, each of digital photograph images being drawn in such a manner that each of digital photograph images has a size proportional to a distance from the view-point to the drawing position;
imaging the virtual three-dimensional space, in which each of digital photograph images is drawn, for a predetermined range of field of view from the view-point; and
outputting the imaged virtual three-dimensional space.

7. A program configured to cause an electronic apparatus to execute steps of:
storing
a plurality of digital photograph images,
shooting date and time information indicating a shooting date and time of each of the digital photograph images, and
shooting location information indicating a shooting location of each of the digital photograph images;
obtaining a current date and time;
obtaining a current location;
drawing each of digital photograph images at a drawing position based on the shooting date and time and the shooting location in a virtual three-dimensional space, the virtual three-dimensional space including
one of a time axis corresponding to the shooting date and time and a distance axis corresponding to the shooting location in a radial direction of a circle having a center at a view-point of a user, the view-point corresponding to the current date and time and the current location, and
a direction axis corresponding to the shooting location in a circumferential direction of the circle, each of digital photograph images being drawn in such a manner that each of digital photograph images has a size proportional to a distance from the view-point to the drawing position;
imaging the virtual three-dimensional space, in which each of digital photograph images is drawn, for a predetermined range of field of view from the view-point; and
outputting the imaged virtual three-dimensional space.
